(19) United States
(12) Patent Application Publication
(10) Pub. No.: US 2005/0067226 A1
(43) Pub. Date: Mar. 31, 2005

(54) Fletchall adjustable-sefety ladder

(76) Inventor: Allen Herbert Fletchall, Mesa, AZ (US)

Correspondence Address: Allen H. Fletchall, 2728 Leisure World, Mesa, AZ, 85206, US

(21) Appl. No.: 10/656,852

(22) Filed: Sep. 8, 2003

(51) Int. Cl. E06C 1/00

(52) U.S. Cl. 182/166

(57) ABSTRACT

A ladder that is more user friendly than the arts that are on the market today. This is accomplished by moving the steps of the ladders closer together than present day ladders, and by putting a warning bell on the second step from the bottom warning there is another step below before landing on a solid surface. Adjustable legs are a new feature in this new art of modem ladders. This eliminates time spent looking for a block or another object to put under the leg. Thus saving time. Having the steps closer together makes it easier for the elderly and people with shorter legs to assend and desend the ladder.

### FIELD OF INVENTION

This invention relates to a step ladder or extension ladder with adjustable length legs in an up and down adjustment position that prior arts do not have. New features are all explained in the claims of this document. Features that prior arts do not have.

### SUMMARY OF INVENTION

This invention is a more realistic and safer ladder for the user than prior arts.

### DESCRIPTION OF DRAWINGS

FIG. 1 Shows the new art in its entirety.

FIG. 1A Shows the handles and the cable that replace the adjustable feet of the apparatus.

FIG. 2 Depicts the adjusting mechanism in relation to the ladder legs and the motion direction of the adjusting levers.

FIG. 3 Tells us the location and the function of the ladder leg-leveling device.

FIG. 4 Demonstrates the extra service the top step gives us with a slide out tool tray, a handy tack well and hammer hole and a place for two screw drivers.

FIG. 5 Allows us to see how a new safety device that can save accidents by having simple warning of another step below before getting off the ladder completely.

### DESCRIPTION OF PREFERRED EMBODIMENT

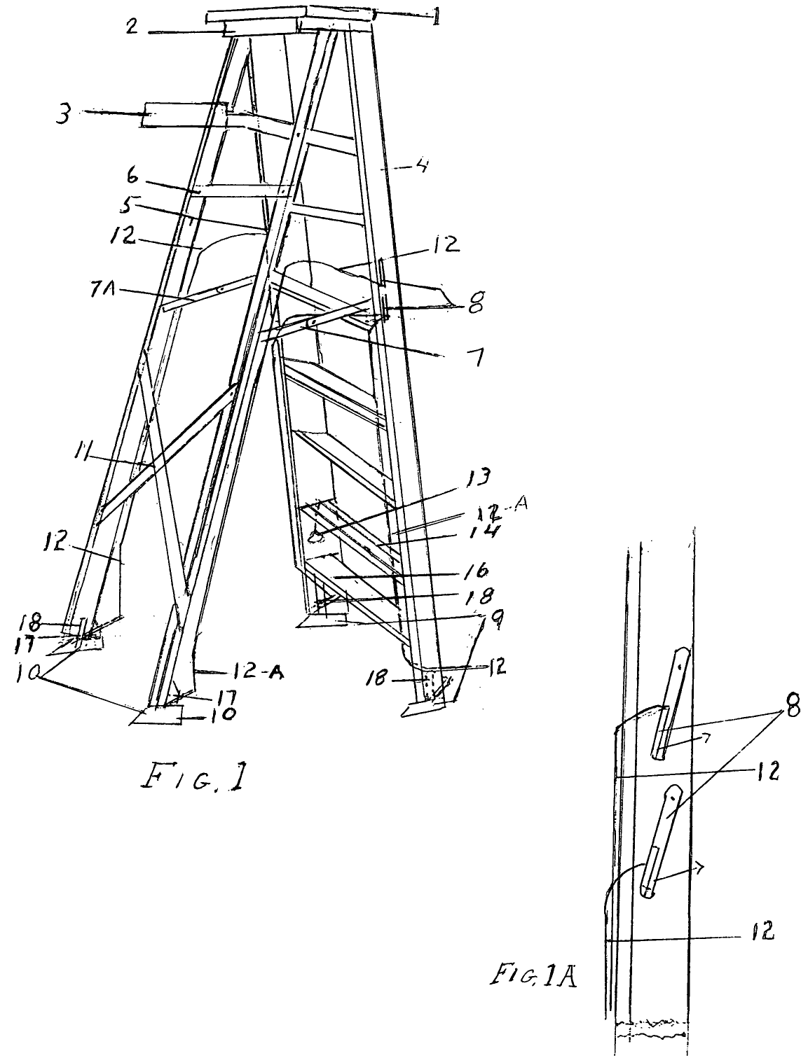

FIG. 1 Displays the new art in its entirety.

FIG. 1A Shows the right front leg (4) with adjustment levers.

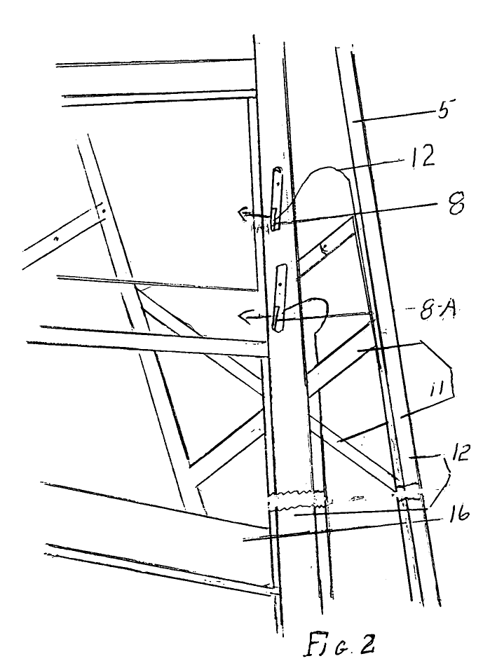

FIG. 2 Depicts step (16) front leg (4) back leg (5) with hinged brace (6) That holds the front leg and back leg apart when standing open or in use. Back leg (5) cross brace (11).

FIG. 3 Tells us about the leg adjustment apparatus (18) (19) and (12).

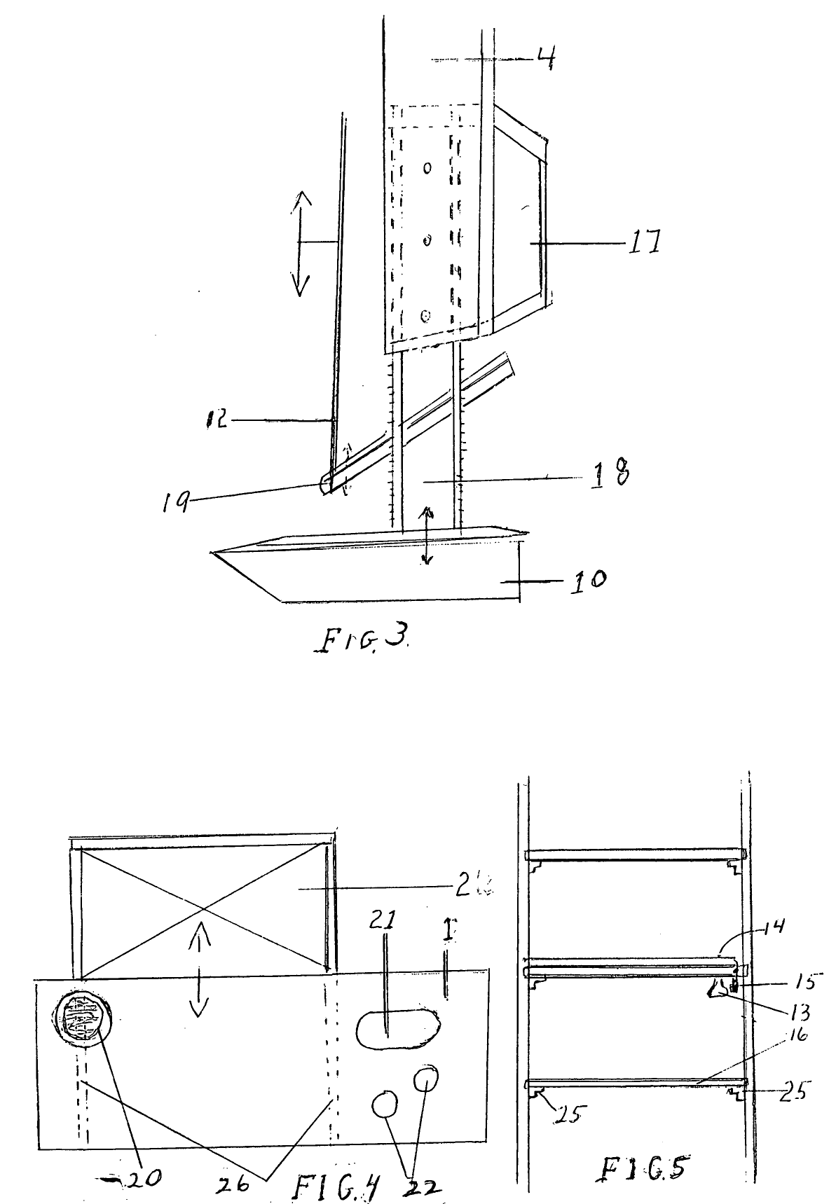

FIG. 4 Makes for showing the extra conveniences the new art displays, slide out service tray (2) hammer hole (21) two screwdrivers holes (22) and tack well (20).

FIG. 5 Displays 3 steps (24-13-13) as they are anchored to the legs (4) with 90 degree angle anchors (25) holding all steps to the leg. FIG. 5 shows the safety assembly device (14-15-16).

1. I claim a ladder of this making is better for the user to use than the prior arts because it Is easier to ascend and descend. The distance between the steps is less than present day ladders which makes it significantly easier to navigate, (especially for older people or the handicapped) or for carrying a load up the ladder. Because of the closeness of the steps puts the user in a closer distance to the task at hand. With adjustable legs the ladder can be leveled (made stable) by using the leveling apparatus,
This ladder can be made of fiberglass, composite material or metals.
With the fold out shelf, hammer hole, two screw driver holes, tack well and one of new features main feature of the new art is a fifty percent wider step which makes it more comfortable to stand on over a extended period
One of the main features of the new art is the fifty percent wider steps which makes the ladder more comfortable to stand on over an extended period of time.
